(19) United States
(12) Patent Application Publication
(10) Pub. No.: US 2026/0314619 A1
(43) Pub. Date: Oct. 15, 2026

(54) Automatic Process to Preserve Brewed Coffee Freshness and Enhance Flavor in Heated

(71) Applicant: Steven Nyman, Boynton Beach, FL (US)

(72) Inventor: Steven Nyman, Boynton Beach, FL (US)

(21) Appl. No.: 19/532,932

(22) Filed: Feb. 6, 2026

Related U.S. Application Data
(60) Provisional application No. 63/787,589, filed on Apr. 11, 2025.

(51) Int. Cl. A23B 90/10; A23L 2/54; B01F 23/231; B01F 101/14

(52) U.S. Cl. CPC A23B 90/10; A23L 2/54; B01F 23/2312; B01F 2101/14

(57) ABSTRACT

A system and method for preserving brewed coffee and other heated beverages using gas-induced circulation and a surface foam barrier reducing oxidation during heated holding.

### CROSS-REFERENCE TO RELATED APPLICATIONS

This application claims priority to U.S. Provisional Application No. 63/787,589, filed Apr. 11, 2025, the entirety of which is incorporated herein by reference.

### FIELD OF THE INVENTION

The invention relates to preservation of brewed coffee and other heated beverages using gas-induced bubble circulation and formation of a surface foam barrier.

### BACKGROUND OF THE INVENTION

Brewed coffee held at elevated temperature may degrade due to oxidation, stratification, and localized overheating. The invention provides gentle non-agitating preservation using gas-induced bubble circulation.

### SUMMARY OF THE INVENTION

Gas bubbles introduced into a heated beverage induce gentle circulation and form a surface foam barrier reducing oxidation and preserving flavor during heated holding.

### BRIEF DESCRIPTION OF THE DRAWINGS

FIG. 1 illustrates a beverage container with gas introduction and diffuser.

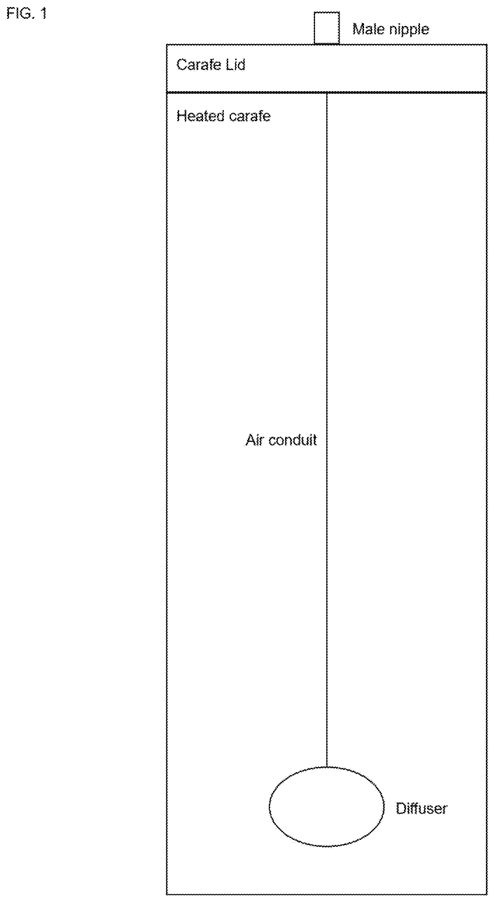

FIG. 2 illustrates a coffeemaker system including a brew head and carafe.

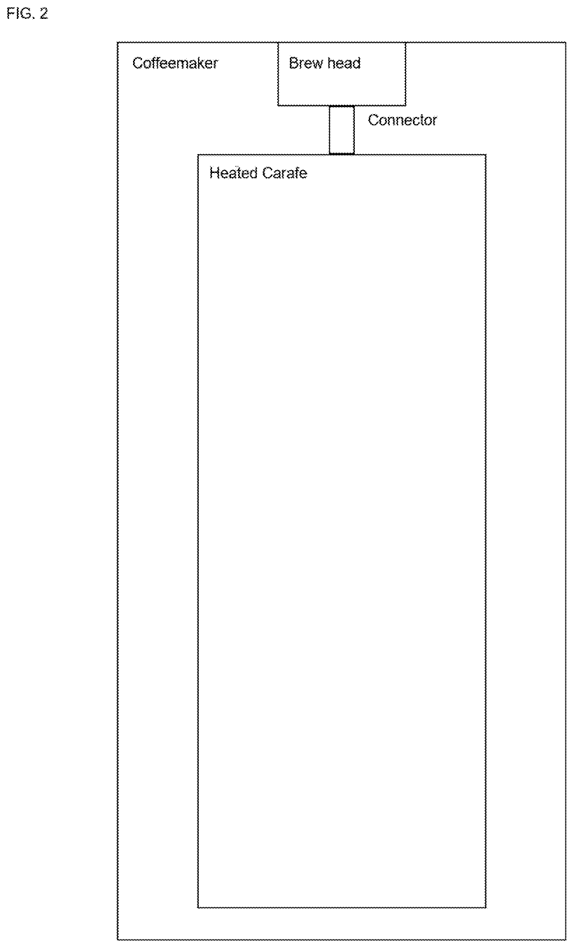

FIG. 3 illustrates a diffuser and conduit arrangement within a container.

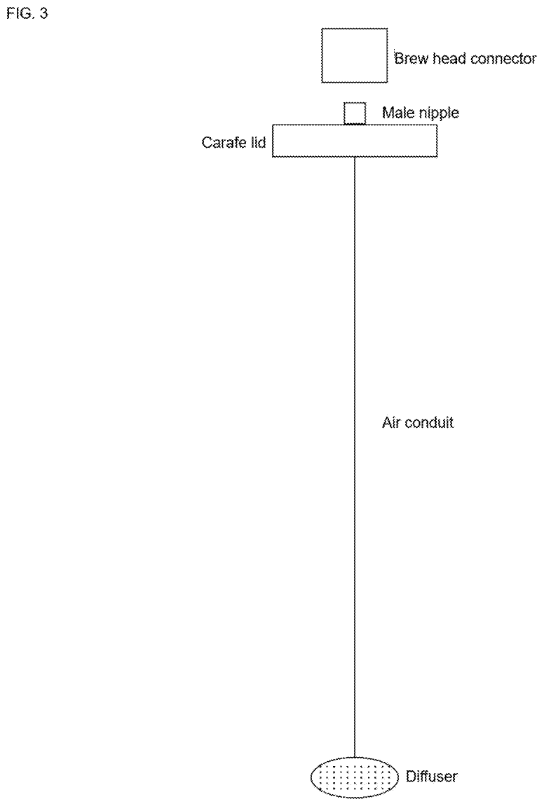

FIG. 4 illustrates a gas delivery system including pump, filter, and valve.

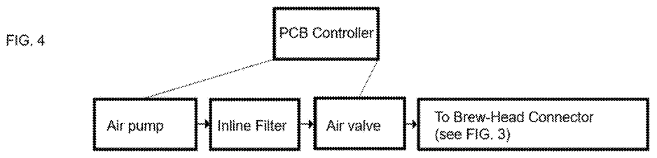

FIG. 5 illustrates bubble circulation and formation of a surface foam layer.

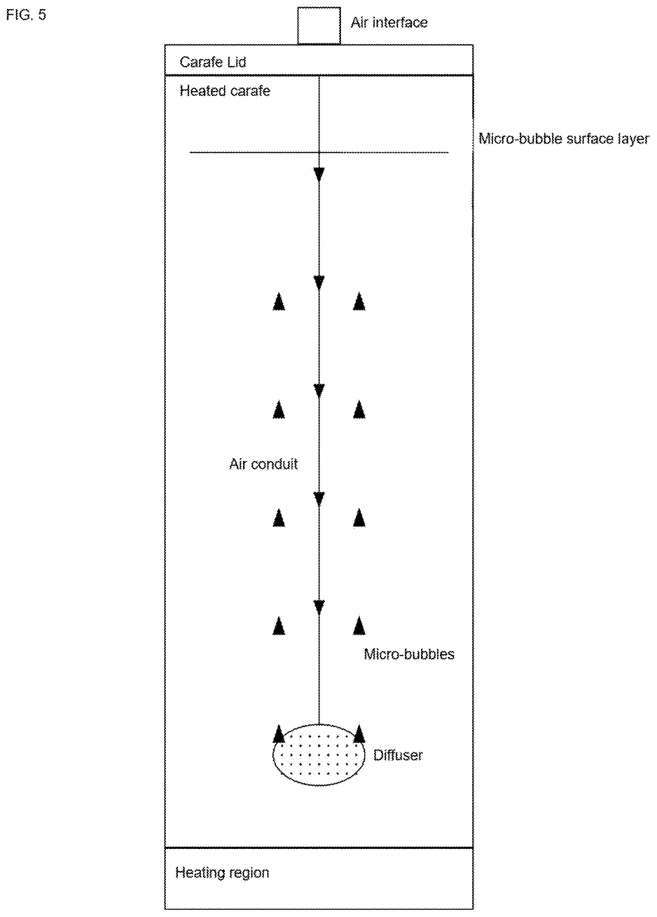

### DETAILED DESCRIPTION OF THE INVENTION

An air pump, inline filter, control valve, and electronic controller may regulate gas introduction continuously or intermittently. The heat source may be positioned at the bottom, side, surrounding jacket, internal or immersion heater, or any configuration capable of maintaining temperature. The foam barrier may be formed by micro-bubbles or other gas-induced foam-forming mechanisms. The foam barrier is distinct from espresso crema, which forms during pressure-based extraction rather than post-brew preservation.

### STATEMENT REGARDING SUBSTITUTE SPECIFICATION

The substitute specification contains no new matter.

1. A system for preserving flavor and thermal uniformity of a heated liquid beverage within a heated container, comprising: a gas conduit extending into the liquid; a diffuser positioned below a surface of the liquid and fluidly connected to the conduit; a gas source configured to deliver gas through the diffuser to generate microbubbles within the liquid; wherein the microbubbles induce gentle circulation of the liquid sufficient to reduce thermal stratification and localized overheating during heated holding while limiting turbulent agitation.

2. A method for preserving flavor of a heated beverage during extended heated holding, comprising: introducing gas through a submerged diffuser to generate microbubbles within the beverage; inducing circulation of the beverage via rising microbubbles; reducing thermal stratification within the beverage; and forming a surface microbubble layer that reduces oxidative degradation of the beverage.

3. A beverage preservation apparatus comprising: a heated container configured to hold a beverage; a gas pump; a gas conduit extending into the container; a diffuser positioned in a lower region of the container; a controller configured to regulate gas delivery; wherein regulated gas delivery produces microbubbles that circulate the beverage and reduce degradation during heated holding.

4. The system of claim 1, wherein the diffuser produces bubbles predominantly within a microbubble size range less than approximately 200 microns.

5. The system of claim 1, wherein circulation induced by the microbubbles maintains substantially uniform temperature throughout the beverage.

6. The system of claim 1, wherein rising microbubbles create gentle convection without turbulent mixing.

7. The system of claim 1, wherein coalescing microbubbles form a surface foam layer that reduces oxygen exposure of the beverage.

8. The system of claim 1, further comprising an inline gas filter positioned upstream of the diffuser.

9. The system of claim 1, further comprising a flow control valve configured to regulate gas delivery rate.

10. The system of claim 1, wherein gas delivery is intermittent.

11. The system of claim 1, wherein the heated container comprises a coffee carafe.

12. The system of claim 1, wherein the diffuser is positioned near a bottom central region of the container.

13. The system of claim 1, wherein the gas source comprises a low-pressure air pump.

14. The system of claim 1, wherein the gas source and controller are configured to be positioned within a handle of the heated container.

15. The system of claim 1, wherein the gas conduit is configured to extend into the liquid from an upper region of the heated container and is further configured to be routed through a handle of the heated container.

16. The system of claim 1, wherein the gas conduit is removably coupled to the heated container at an upper region of the container.

17. The system of claim 1, wherein the gas source is configured to be powered by an internal rechargeable power source.

18. The system of claim 1, wherein the gas source is configured to be positioned external to the heated container and fluidly connected to the gas conduit.

19. The method of claim 2, wherein the surface microbubble layer forms a protective foam barrier that reduces oxidation.

20. The apparatus of claim 3, wherein the gas conduit connects to the container through a removable coupling.
